(19) United States
(12) Patent Application Publication
(10) Pub. No.: US 2018/0370194 A1
(43) Pub. Date: Dec. 27, 2018

(54) ASYMMETRIC LAMINATED GLASS

(71) Applicant: SAINT-GOBAIN GLASS FRANCE, Courbevoie (FR)

(72) Inventors: Corinne CLAIREAUX, Paris (FR); Carole FREDY, Nogent-Sur-Marne (FR)

(21) Appl. No.: 16/062,440

(22) PCT Filed: Dec. 14, 2016
(86) PCT No.: PCT/FR2016/053420

§ 371 Date: Jun. 14, 2018

(30) Foreign Application Priority Data
Dec. 17, 2015 (FR) 1562665

(51) Int. Cl. B32B 17/10; C03C 3/091; C03C 3/087

(52) U.S. Cl. CPC B32B 17/10036; B32B 17/10119; B32B 17/10137; B32B 17/10743; C03C 21/002; C03C 3/091; C03C 3/087; B32B 17/1077; B32B 17/10788; B32B 17/10761

(57) ABSTRACT

A laminated glazing includes at least a first glass sheet of soda-lime-silica type, a second glass sheet which is thinner than the first glass sheet and a polymeric interlayer located between the two glass sheets, in which the second glass sheet is a glass of aluminosilicate type including the following oxides within the ranges of contents by weight defined below: SiO₂ between 60.00 and 68.00%; Al₂O₃ between 2.80 and 7.80%; Na₂O between 10.00 and 15.80%; MgO between 4.90 and 10.10%; K₂O between 4.80 and 9.70%; B₂O₃ between 0 and 3.20%; and CaO between 0 and 1.00%.

The present invention relates to an asymmetric laminated glazing consisting of at least two glass sheets, one of the sheets of which is a sheet of thin chemically tempered glass. It relates more particularly to a laminated glazing for use in the field of transportation (automotive, helicopter, aircraft, and the like), in particular as car windscreen.

Laminated glazings are commonly used since they exhibit the advantage of being “safety” glazings. In this type of glazing, a plastic interlayer sheet is placed between the two glass sheets. It is standard, in the automotive field, to use asymmetric glazings, in the sense that the two constituent glass sheets of the glazing have different thicknesses. Current developments are attempting in particular to reduce the weight of the glazings and consequently are directed at decreasing the thicknesses of the glass sheets constituting them. However, it is necessary for the laminated glazings, even lightened, to exhibit a mechanical strength compatible with the applications desired. One of the possibilities which makes it possible to reinforce the mechanical strength of the glazing consists in using at least one glass sheet which has a surface region in compression and a central region in tension. This type of glass sheet is obtained in particular by subjecting it to a thermal or chemical tempering process. Chemical tempering is a process which consists in carrying out an ion exchange within the glass sheet: the surface replacement of an ion (generally an alkali metal ion, such as sodium or lithium) by an ion with a greater ionic radius (generally another alkali metal ion, such as potassium or sodium) from the surface of the glass down to a depth commonly denoted by “exchange depth” makes it possible to create, at the surface of the glass sheet, residual compressive stresses down to a certain depth, often known as “compression depth”. This depth depends in particular on the duration of the ion-exchange treatment, on the temperature at which the latter is carried out and also on the composition of the glass sheet. It is necessary to find a compromise between the duration and the temperature of this treatment, in particular taking into account the production constraints in the lines for the manufacture of the glazings.

An asymmetric laminated glazing comprising a chemically tempered glass sheet is often a glazing consisting of two glass sheets with a different thickness and also with a different chemical composition. In point of fact, for the applications desired and in particular in the automotive field, it is necessary to give a certain curvature to the glazing and to carry out a bending of the constituent glass sheets of the glazing before they are assembled. It is advantageous to use bending techniques which make it possible to simultaneously bend the glass sheets. This makes it possible in particular to ensure that the sheets will exhibit exactly the same curvatures, which will facilitate the assembling thereof. In the bending processes, the two glass sheets are positioned one above the other and are supported along their marginal end parts in a substantially horizontal fashion by a frame or skeleton having the desired profile, that is to say the definitive profile of the glazing after assembling. The glass sheet with the thinnest thickness is positioned above the thicker glass sheet so that the support of the thin sheet on the thicker sheet takes place homogeneously over the whole of the regions in contact. Thus positioned on the frame, the two glass sheets pass into a bending furnace. Given that the two glass sheets have different chemical compositions, their behaviour during this bending stage is different and the risk of appearance of residual defects or stresses may consequently be increased.

Furthermore, in addition to the requirements relating to the mechanical strength properties and the requirements related to the process for bending the glazing, it is necessary for the glazings to have a good chemical resistance and in particular a good hydrolytic resistance. This is because it is necessary for the glass, after it has been manufactured, to be able to stored for a certain time, in particular in stacks, while retaining the initial properties of the glazing, in particular its optical quality.

Glass sheet compositions exhibiting, after chemical tempering, high compressive stresses over a great depth and also a good hydrolytic resistance are described in particular in Patent EP 0 914 298. However, the tempering times described in this document are not compatible with processes for the production of glazing for automotive applications, which require markedly shorter chemical treatment times. Furthermore, the compositions of the glasses described in this document do not necessarily make it possible to be bent simultaneously with a glass sheet of soda-lime-silica type.

It is an aim of the invention to provide asymmetric laminated glazings which exhibit a high mechanical strength and a good hydrolytic resistance and for which the two glass sheets constituting it are such that they can be bent simultaneously.

To this end, a subject-matter of the invention is a laminated glazing which comprises at least a first glass sheet of soda-lime-silica type, a second glass sheet which is thinner than the first glass sheet and a polymeric interlayer located between the two glass sheets, the second glass sheet being a glass of aluminosilicate type comprising the following oxides within the ranges of contents by weight defined below:

| | |
|---|---|
| SiO₂ | between 60.00 and 68.00% |
| Al₂O₃ | between 2.80 and 7.80% |
| Na₂O | between 10.00 and 15.80% |
| MgO | between 4.90 and 10.10% |
| K₂O | between 4.80 and 9.70% |
| B₂O₃ | between 0 and 3.20% |
| CaO | between 0 and 1.00%. |

The content of SiO₂, the main former oxide of the glass, is between 60.00% and 68.00% by weight. This range advantageously makes it possible to have stable compositions, which exhibit a good aptitude for chemical reinforcement and viscosities comparable with the ordinary processes for the manufacture of glass sheets (floating of the glass on a bath of molten metal) and with the bending processes in order to make sure of simultaneous bending during the manufacture of a laminated glazing comprising a sheet of soda-lime-silica type.

The content by weight of Al₂O₃ is between 2.80 and 7.80%, which makes it possible to vary the viscosity of the glass so as to remain within viscosity ranges which make it possible to manufacture the glasses without increasing the forming temperatures. The alumina also has an influence on the performances at the level of the chemical reinforcement of the glasses.

The sodium and potassium oxides make it possible to keep the melting temperatures and the viscosity of the glasses within the acceptable limits. The simultaneous presence of these two oxides in particular has the advantage of increasing the hydrolytic resistance of the glasses and the rate of interdiffusion between the sodium and potassium ions.

The content by weight of magnesium oxide varies between 4.90 and 10.10%. This oxide promotes the melting of the glass compositions and improves the viscosity at high temperatures, while contributing to the increase in the hydrolytic resistance of the glasses.

The content by weight of calcium oxide is limited to 1% as this oxide is harmful to the chemical tempering.

Advantageously, the second glass sheet is reinforced by an exchange of sodium ions by potassium ions. The second glass sheet is reinforced by exchange of surface ions over an ion exchange depth of at least 30 μm and the surface stress of the glass sheet is at least 550 MPa, preferably at least 600 MPa. This profile of stresses is obtained by an ion exchange treatment at a temperature of less than 490° C., for example at 460° C., for a period of time of 2 hours.

The exchange depth is estimated by the weight uptake method. It is deduced from the uptake in weight of the samples while assuming that their diffusion profile is approximated by an “erfc” function with the convention that the exchange depth corresponds to the depth for which the concentration of potassium ion is equal to that of the glass matrix to within about 0.5% (as described in René Gy, Ion Exchange for Glass Strengthening, Materials Science and Engineering: B, Volume 149, Issue 2, 25 Mar. 2008, pages 159-165). Here the thickness of the test specimen is negligible in view of the dimensions of the sample tested and the uptake in weight Δw can be related to the exchange depth e_{exch} by the formula:

$${e}_{exch} = \sqrt{π} \frac{Δ W}{{w}_{i}} \frac{{M}_{tot} {t}_{v}}{{α}_{Na 2 O} \cdot ( {M}_{K 2 O} - {M}_{Na 2 O} )}$$

with wᵢ the initial weight of the test specimen, Mₜₒₜ the total molar mass of the glass, M_{K2O} and M_{Na2O} the molar masses of the oxides K₂O and Na₂O respectively, α_{Na2O} the molar percentage of sodium and tᵥ the thickness of the test specimen.

Furthermore, in order to have a good corrosion resistance in stacks, the second glass sheet advantageously exhibits a good resistance to a hydrolytic resistance test. Hydrolytic resistance is understood to mean the ability which a glass has to dissolve by leaching. This resistance is thus dependent in particular on the chemical composition of the glass. It is evaluated by the measurement of the loss in weight of finely ground glass powders after attack with water. The attack with water on the glass as grains or “DGG test” is a method which consists in immersing 10 grams of ground glass, the size of the grains of which is between 360 and 400 μm, in 100 ml of water brought to boiling point for a period of time of 5 hours. After rapid cooling, the solution is filtered and a predetermined volume of filtrate is evaporated to dryness. The weight of the dry matter obtained makes it possible to calculate the amount of glass dissolved in the water. The amount of glass extracted is thus determined in mg per gram of glass tested, which is denoted “DGG”. The lower the value of the DGG, the more resistant the glass is to hydrolysis. Advantageously, the second glass sheet of the glazing according to the present invention has a DGG value of less than 30 mg.

It is essential for the two constituent glass sheets of the glazing according to the present invention to be able to be bent simultaneously. The glazing according to the invention is characterized in that the difference between the temperatures of each of the constituent glass sheets of the glazing for which the viscosity has a value of 10^{10.3} poises, denoted T(log η=10.3), is less, in absolute value, than 30° C. This temperature is obtained by taking the mean between the upper annealing temperature, that is to say the temperature at which the viscosity of the glass has a value of 10¹³ poises, and the softening temperature, that is to say the temperature at which the viscosity of the glass has a value of 10^{7.6} poises for each of the glass sheets. The upper annealing temperature corresponds to the temperature for which the viscosity of the glass is strong enough for the disappearance of the stresses to be able to be carried out completely in a predetermined time (relaxation time of the stresses of approximately 15 minutes). This temperature is also sometimes known as “stress relaxation temperature”. This temperature is conventionally measured according to Standard NF B30-105. The softening temperature, also sometimes known as “Littleton temperature”, is for its part defined as being the temperature at which a glass strand with a diameter of approximately 0.7 mm and with a length of 23.5 cm elongates by 1 mm/min under its own weight (Standard ISO 7884-6). This temperature can be measured or calculated as explained in the publication Fluegel A., 2007, Europ. J. Glass Sci. Technol. A, 48 (1), 13-30. Preferably, the difference between the temperature T₁ (log η=10.3) of the first glass sheet and the temperature T₂ (log η=10.3) of the second glass sheet is less in absolute value than 23° C. This slight difference in temperature makes it possible to make sure that the two glass sheets of the glazing according to the invention can be bent simultaneously and then assembled with the polymeric interlayer, without the risk of bringing about the appearance of defects, such as optical defects, in the glazing.

Thus, by combining a first glass sheet of soda-lime-silica type with a second glass sheet of aluminosilicate type with the chemical composition described above, the inventors have discovered that it is possible to obtain, by simultaneous bending of the two glass sheets, a glazing exhibiting the desired properties of both mechanical strength and chemical resistance.

Preferably, the second glass sheet is a glass of aluminosilicate type comprising the following oxides within the ranges of contents by weight defined below:

| | |
|---|---|
| SiO₂ | between 60.00 and 67.00% |
| Al₂O₃ | between 2.80 and 7.80% |
| Na₂O | between 10.00 and 13.50% |
| MgO | between 4.90 and 10.10% |
| K₂O | between 8.50 and 9.70% |
| B₂O₃ | between 0 and 3.20% |
| CaO | between 0 and 1.00%. |

The glasses exhibiting this composition advantageously have a good chemical resistance and a good strength. They also have a temperature T₂ (log η=10.3) close to the temperature T₁ (log η=10.3) of the first glass sheet, which makes it possible to more easily bend the two sheets simultaneously.

The first glass sheet is of soda-lime-silica type and comprises the following oxides within the ranges of contents by weight defined below:

| | |
|---|---|
| SiO₂ | between 65.00 and 75.00% |
| Na₂O | between 10.00 and 20.00% |
| CaO | between 2.00 and 15.00% |
| Al₂O₃ | between 0 and 5.00% |
| MgO | between 0 and 5.00% |
| K₂O | between 0 and 5.00%. |

The compositions of the first and second glass sheets mentioned above indicate only the essential constituents. They do not give the minor elements of the composition, such as the refining agents conventionally used, such as arsenic, antimony, tin or cerium oxides, halogens or metal sulphides. The compositions can also contain colouring agents, such as iron oxides or cobalt, chromium, copper, vanadium, nickel and selenium oxide, which are most of the time necessary for the applications in the automotive field.

The constituent glass sheets of the glazing according to the present invention have different thicknesses and the first glass sheet is the thickest sheet. The first glass sheet has a thickness of at most 2.1 mm, preferably at most 1.6 mm. The second glass sheet, which is thinner than the first, has a thickness of at most 1.5 mm. Preferably, this sheet has a thickness of at most 1.1 mm, indeed even is less than 1 mm. Advantageously, the second glass sheet has a thickness of less than or equal to 0.7 mm. The thickness of the sheet is at least 50 μm.

The fact of using thin glass sheets makes it possible to lighten the laminated glazing and consequently meets the specifications currently demanded by manufacturers who are seeking to reduce the weight of the vehicles.

The polymeric interlayer placed between the two glass sheets consists of one or more layers of thermoplastic material. It can in particular be made of polyurethane, of polycarbonate, of polyvinyl butyral (PVB), of polymethyl methacrylate (PMMA), of ethylene/vinyl acetate (EVA) or of ionomer resin. The polymeric interlayer can be provided in the form of a multilayer film having specific functionalities, such as, for example, better acoustic or UV-stabilizing properties, and the like. Conventionally, the polymeric interlayer comprises at least one PVB layer. The thickness of the polymeric interlayer is between 50 μm and 4 mm. Generally, its thickness is less than 1 mm. In automotive glazings, the thickness of the polymeric interlayer is conventionally 0.76 mm. When the constituent glass sheets of the glazing are very thin, it can be advantageous to use a polymeric interlayer with a thickness of greater than 1 mm, indeed even greater than 2 or 3 mm, in order to confer stiffness on the laminated glazing, without contributing an excessively great increased weight.

Another subject-matter of the invention is a process for the manufacture of the laminated glazing according to the present invention, comprising a stage of simultaneous bending of the first and the second glass sheet, a stage of ion exchange of the second glass sheet and a stage of assembling the two glass sheets with the polymeric interlayer.

The constituent glass sheets of the glazing according to the present invention can be manufactured according to different known processes, such as the float glass process, in which the molten glass is poured onto a bath of molten tin, the process of rolling between two rolls (or fusion draw process), in which the molten glass overflows from a channel and will form a sheet by gravity, or also the down-draw process, in which the molten glass flows downward via a slit, before being drawn to the desired thickness and simultaneously cooled.

The stage of bending the first and second glass sheets is carried out simultaneously. The two glass sheets are positioned one above the other in a bending frame or skeleton, the thinnest glass sheet being that of the top, furthest from the skeleton. The assembly is thus introduced into a bending furnace. The two sheets are separated by a pulverulent agent of talc, calcite or ceramic powder type in order to prevent frictional actions and the sticking of one sheet to the other. The bending thus carried out is a forming by gravity and/or by pressing.

The ion exchange which the second glass sheet is subjected to is generally carried out by placing said sheet in a bath filled with a molten salt of the desired alkali metal ion. This exchange usually takes place at a temperature lower than the transition temperature of the glass and than the degradation temperature of the bath, advantageously at a temperature of less than 490° C. The duration of the ion exchange is less than 24 hours. However, it is desirable for this change time to be shorter in order to be compatible with the production rates of the processes for the manufacture of laminated glazings for the automotive industry. The duration of treatment is, for example, less than or equal to 4 hours, preferably less than or equal to 2 hours. The exchange temperatures and the exchange times are to be adjusted as a function of the composition of the glass, of the thickness of the glass sheet, and also of the thickness in compression and of the desired level of stresses. In particular, good performances in tempering are obtained when the latter is carried out for a period of time of 2 hours at a temperature of 460° C. The ion exchange can advantageously be followed by a heat treatment stage in order to decrease the core tensile stress and to increase the depth under compression.

The assembling stage consists subsequently in assembling the two glass sheets with the thermoplastic interlayer by placing under pressure in an autoclave and increasing the temperature.

The laminated glazing according to the present invention advantageously constitutes a glazing for the automotive industry and in particular a windscreen. The first sheet of soda-lime-silica type and the second thinner sheet of aluminosilicate type are bent together before being assembled with the polymeric interlayer to form the glazing according to the present invention. The second sheet is that which is above in the bending frame. Once fitted into the vehicle, this second glass sheet corresponds to the internal glass sheet, that is to say that placed towards the interior of the passenger compartment. The first glass sheet is thus that which is placed towards the exterior. The glass sheets can thus be assembled directly after the bending stage, without requiring the inversion of the order of the glass sheets.

The examples below illustrate the invention without limiting the scope thereof.

Glazings according to the invention were prepared from different glass sheets of different compositions.

Different compositions for the second glass sheet were prepared and are given in the table below:

TABLE 1

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| SiO₂ | 67.00 | 64.90 | 66.35 | 64.40 | 60.65 | 63.35 | 76.75 | 70.95 | 63.60 |
| Al₂O₃ | 2.80 | 7.50 | 7.60 | 5.30 | 7.70 | 5.95 | 2.95 | 3.00 | 2.75 |
| MgO | 10.05 | 5.05 | 4.95 | 7.30 | 8.40 | 8.95 | 5.00 | 5.05 | 10.20 |
| Na₂O | 10.15 | 10.05 | 15.65 | 12.70 | 13.10 | 12.10 | 9.85 | 15.55 | 15.95 |
| K₂O | 9.40 | 9.25 | 4.80 | 7.30 | 9.55 | 9.15 | 4.75 | 4.75 | 4.50 |
| B₂O₃ | 0.10 | 2.85 | 0.10 | 3.00 | 0 | 0 | 0.15 | 0.15 | 2.70 |
| Various | 0.50 | 0.40 | 0.55 | — | 0.60 | 0.50 | 0.55 | 0.55 | 0.30 |
| Total | 100.00 | 100.00 | 100.00 | 100.00 | 100.00 | 100.00 | 100.00 | 100.00 | 100 |

Table 2 gives the values of the upper annealing temperatures T(log η=13), the Littleton temperatures, the temperatures for which the viscosity of the glass has a value of 10.3 poises T(log η=7.6), the DGG value measured in mg, and also the exchange depth and the surface stress in MPa, after an ion exchange with a duration of 24 h at a temperature of 360° C., for each of the conditions given in the table above (thickness of the samples tested 2.5 mm). The compositions of Examples 7, 8 and 9 are not in accordance with the invention.

TABLE 2

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| T(log | 549 | 549 | 510 | 540 | 557 | 552 | 568 | 489 | 525 |
| η = 13) | | | | | | | | | |
| in ° C. | | | | | | | | | |
| T(log | 738 | 741 | 713 | 722 | 724 | 729 | 757 | 694 | 709 |
| η = 7.6) | | | | | | | | | |
| in ° C. | | | | | | | | | |
| T(log | 643.5 | 645 | 611.5 | 631 | 640.5 | 640.5 | 662.5 | 591.5 | 617 |
| η = 10.3) | | | | | | | | | |
| in ° C. | | | | | | | | | |
| DGG | 26.7 | 11.8 | 24.5 | 24.5 | 23.5 | 23.5 | 15.5 | 49 | 102 |
| (mg) | | | | | | | | | |
| Exchange | 63 | 36 | 39 | 30 | 42 | 45 | 40 | 40 | 19 |
| depth | | | | | | | | | |
| (μm) | | | | | | | | | |
| Surface | 608 | 608 | 717 | 600 | 624 | 630 | 521 | 559 | 846 |
| stress | | | | | | | | | |
| (MPa) | | | | | | | | | |

After an ion exchange at 440° C. for 4 h on a test specimen with a formulation in accordance with Example 1 and with a thickness of 0.7 mm, a surface stress of 552 MPa and an exchange depth of 39 μm are achieved.

Glazings according to the present invention are manufactured by using a first glass sheet with the following composition, denoted sheet F1:

| | |
|---|---|
| SiO₂ | 71.50% |
| Na₂O | 14.10% |
| CaO | 8.75% |
| Al₂O₃ | 0.80% |
| MgO | 4.00% |
| K₂O | 0.25% |
| Various | 0.60% |

The characteristic temperatures of this composition are respectively 545° C. and 725° C. for T(log η=13) and T(log η=7.6). The temperature T(log η=10.3) thus has a value of 635° C.

The asymmetric laminated glazings are manufactured by using a first glass sheet with the soda-lime-silica composition given above with a thickness of 1.6 mm, a PVB interlayer with a thickness of 0.76 mm and a second glass sheet with a thickness of 0.55 mm obtained after thinning the glass sheets, the composition of which is given in Table 1.

The following Table 3 specifies the difference between the T(log η=10.3) temperatures of the constitute glass sheets of the laminated glazing. The notation used to characterize the glazing is the following F1/F2.x, in which F1 specifies that it is a matter of the combination of a first sheet of composition F1 and of a second sheet of composition x (where x varies from 1 to 9 and corresponds to Examples 1 to 9 given in Table 1). Thus, the sheet F2.1 is the second glass sheet, the composition of which is that of Example 1.

TABLE 3

| | Laminate glazing | | | | | | | | |
|---|---|---|---|---|---|---|---|---|---|
| | F1/ | F1/ | F1/ | F1/ | F1/ | F1/ | F1/ | F1/ | F1/ |
| | F2.1 | F2.2 | F2.3 | F2.4 | F2.5 | F2.6 | F2.7 | F2.8 | F2.9 |
| Difference in | 10.5 | 12 | 21.5 | 2 | 7.5 | 7.5 | 29.5 | 41.5 | 16 |
| the | | | | | | | | | |
| T(log | | | | | | | | | |
| η = 10.3) | | | | | | | | | |
| temperatures | | | | | | | | | |

Only the glasses prepared with a second sheet in accordance with the invention make it possible to obtain laminated glazings which correspond simultaneously to the criteria of mechanical strength, of resistance to corrosion of the glass before forming and chemical tempering and of possibility of simultaneous bending.

1. A laminated glazing comprising at least a first glass sheet of soda-lime-silica type, a second glass sheet which is thinner than the first glass sheet and a polymeric interlayer located between the two glass sheets, wherein the second glass sheet is a glass of aluminosilicate type comprising the following oxides within the ranges of contents by weight defined below:

| | |
|---|---|
| SiO₂ | between 60.00 and 68.00% |
| Al₂O₃ | between 2.80 and 7.80% |
| Na₂O | between 10.00 and 15.80% |
| MgO | between 4.90 and 10.10% |
| K₂O | between 4.80 and 9.70% |
| B₂O₃ | between 0 and 3.20% |
| CaO | between 0 and 1.00%. |

2. The laminated glazing according to claim 1, wherein the first glass sheet is a glass of soda-lime-silica type comprising the following oxides within the ranges of contents by weight defined below:

| | |
|---|---|
| SiO₂ | between 65.00 and 75.00% |
| Na₂O | between 10.00 and 20.00% |
| CaO | between 2.00 and 15.00% |
| Al₂O₃ | between 0 and 5.00% |
| MgO | between 0 and 5.00% |
| K₂O | between 0 and 5.00%. |

3. The laminated glazing according to claim 1, wherein the second glass sheet comprises the following oxides within the ranges of contents by weight defined below:

| | |
|---|---|
| SiO₂ | between 60.00 and 67.00% |
| Al₂O₃ | between 2.80 and 7.80% |
| Na₂O | between 10.00 and 13.50% |
| MgO | between 4.90 and 10.10% |
| K₂O | between 8.50 and 9.70% |
| B₂O₃ | between 0 and 3.20% |
| CaO | between 0 and 1.00%. |

4. The laminated glazing according to claim 1, wherein the second glass sheet is reinforced by chemical tempering with an ion exchange depth of at least 30 μm and has a surface stress of at least 550 MPa.

5. The laminated glazing according to claim 1, wherein the second glass sheet has a hydrolytic resistance such that the DGG is less than 30 mg.

6. The laminated glazing according to claim 1, wherein a difference between the temperatures T(log η=10.3) of each of the glass sheets for which the viscosity has a value of 10^{10.3} poises is less, in absolute value, than 30° C.

7. The laminated glazing according to claim 1, wherein the first glass sheet has a thickness of at most 2.1 mm.

8. The laminated glazing according to claim 1, wherein the second glass sheet, which is thinner than the first glass sheet, has a thickness of at most 1.5 mm.

9. The laminated glazing according to claim 1, wherein the polymeric interlayer placed between the two glass sheets consists of one or more layers of thermoplastic material.

10. The laminated glazing according to claim 9, wherein the thickness of the polymeric interlayer is between 50 μm and 4 mm.

11. A process for the manufacture of the glazing according to claim 1, comprising at least one stage of simultaneous bending of the first and the second glass sheet, a stage of ion exchange of the second glass sheet and a stage of assembling the two glass sheets with the polymeric interlayer.

12. The process according to claim 11, wherein the ion exchange stage takes place at a temperature of less than 490° C. for a period of time of less than 24 hours.

13. The process according to claim 11, wherein, during the bending stage, the second glass sheet, which is thinner than the first sheet, is positioned above the first glass sheet.

14. An automotive glazing obtained by the process according to claim 1, wherein the second glass sheet is placed towards the interior of the passenger compartment.

15. The laminated glazing according to claim 4, wherein the surface stress is of at least 600 MPa.

16. The laminated glazing according to claim 6, wherein the difference between the temperatures T(log η=10.3) of each of the glass sheets for which the viscosity has a value of 10^{10.3} poises is less, in absolute value, than 23° C.

17. The laminated glazing according to claim 7, wherein the first glass sheet has a thickness of at most 1.6 mm.

18. The laminated glazing according to claim 8, wherein the second glass sheet, which is thinner than the first glass sheet, has a thickness of at most 1.1 mm.

19. The laminated glazing according to claim 18, wherein the second glass sheet, which is thinner than the first glass sheet, has a thickness of at most 1 mm.

20. The laminated glazing according to claim 9, wherein the thermoplastic material is made of polyurethane, of polycarbonate, of polyvinyl butyral (PVB), of polymethyl methacrylate (PMMA), of ethylene/vinyl acetate (EVA) or of ionomer resin.

21. The process according to claim 12, wherein the period of time is less than or equal to 4 hours.

22. The process according to claim 21, wherein the period of time is less than or equal to 2 hours.

23. The automotive glazing according to claim 14, wherein the automotive glazing is a windscreen.
